(19) United States
(12) Patent Application Publication
(10) Pub. No.: US 2012/0198709 A1
(43) Pub. Date: Aug. 9, 2012

(54) OSCILLATING BLADE IMPROVEMENT

(75) Inventor: Kevin Ross Inkster, Malaga (AU)

(73) Assignee: ARBORTECH INDUSTRIES LTD, MALAGA, WA (AU)

(21) Appl. No.: 13/501,455

(22) PCT Filed: Oct. 12, 2010
(86) PCT No.: PCT/AU10/01340

§ 371 Date: Apr. 12, 2012

(30) Foreign Application Priority Data
Oct. 12, 2009 (AU) 2009904944

(51) Int. Cl. B23D 57/00; B26D 1/30; B23D 61/18

(52) U.S. Cl. 30/503.5; 83/697; 83/835; 83/13

(57) ABSTRACT

A cutting apparatus of a type having two juxtaposed blades 1 and 2 with each having an outermost cutting edge with teeth 12 and 13, with retention and driving of the blades adapted to effect an oscillatory motion to each of the cutting edges, characterized in that there are means to resist resonant spreading between the blades 1 and 2 when cutting which are that there is a first of the blades 1 having a first portion supported by the first blade with a part 15 which is positioned behind a part 18 of the other blade, and a second blade 2 includes a portion with the part 18 which is positioned behind the part of the first said blade.

This invention relates to a cutting apparatus and in particular without limiting the invention, to a cutting apparatus where two juxtaposed blades are caused to move sequentially with teeth following approximately elliptical paths, blades for this purpose, and a method of cutting.

### BACKGROUND OF THE INVENTION

The cutting action of this invention uses an arrangement functionally based on that which I have described in my earlier patent one example of which is U.S. Pat. No. 5,456,011 filed 12 Oct. 1993.

Cutting with this arrangement is achieved using the described action by having teeth on respective outer selected edges of two juxtaposed blades and then urging the relatively moving teeth on the edge of the respective blades against a surface to be cut.

In practice, using such a cutting arrangement with blades that project to a respective cutting edge will, because of the mechanism controlling the geometry of the cutting action, exhibit differing elliptical paths and differently orientated elliptical paths as one progresses from location to location along the cutting edges.

The effect of this is that cutting, using the system, involves an operator holding the cutting apparatus and urging the relatively moving cutting edges of the blades into a cut and through a cutting stroke.

An issue of concern in the design is to have blades which offer only slight inertial mass resistance because the relative position of each blade is being rapidly changed through a cutting stroke. This is achieved at least in part by maintaining the thickness of the material of each blade as thin as practical.

However, in experiments conducted thus far, the blades which are positioned in a closely juxtaposed position at rest, will, if the blades are thin enough, in many cases, resonate with side to side movements and bounce against each other and this effect results in a spreading between the two juxtaposed blades at least at their respective cutting edges. It is highly desirable to use thinner blades to reduce inertial mass but it is intolerable to have this resonate spread between the blades. This spread in some instances can be as much as several centimeters. Numerous attempts have been made to answer this problem in a way which will not compromise necessarily an overall thickness of the juxtaposed blades, and will not introduce costs that might make the cutting arrangement uneconomic, the object is then is directed to this problem of spreading and achieving a reduction of this effect in a commercial and engineeringly effective manner.

### BRIEF SUMMARY OF THE INVENTION

In one form then the invention can be said to reside in a cutting apparatus of a type having two juxtaposed blades with each having an outermost cutting edge, with retention and driving of the blades adapted to effect an oscillatory motion to each of the cutting edges, a first of the blades having a first portion supported by the first blade with a part which is positioned behind a part of the other blade, and a second blade includes a portion with a part which is positioned behind the part of the first said blade.

In an alternative form of the invention this can be said to reside in a cutting tool comprising two cutting members positioned side by side and each having a toothed cutting edge and being of approximately the same shape, each cutting member being mounted on respective eccentrics of a drive shaft coupled to a motor, each cutting member being guided by respective control links so that the cutting edge of each cutting member prescribes simultaneously in the plane of the toothed edge, simultaneous oscillatory movements in the direction of the toothed edge and in the direction of right-angles thereto with corresponding movements of the respective cutting members being out of the phase, and the teeth of each cutting edge being adapted to each cut when moving individually in the direction of the toothed edge, and a part of the first blade being positioned to be behind a part of the second blade, and the part of the second blade being positioned behind the part of the first blade.

In preference each part is offset with respect to a planar alignment of the blade of which it forms a portion to be substantially aligned with the body of the other blade.

In a further form the invention can be said to reside in a cutting tool comprising:

two juxtaposed cutting members each having a toothed cutting edge of a substantially same shape and extent, each of said cutting members having a drive portion extending in a direction lateral to the cutting edge, said drive portions being in a juxtaposed relation;

a drive means adapted for coupling to a motor and operably interacting with each said drive portions to impart thereto an eccentric movement in a plane of each respective said drive portion about a common axis, the eccentric movement imparted to the respective drive portions being equal and angularly out of phase; and

means to restrain movement of the respective drive portions at a specific location spaced from said common axis to substantially linear movement in a direction radial to the common axis and to angular movement about a respective pivot axis parallel to said common axis, whereby in response to activation of the drive means, the cutting edge of each cutting member prescribes simultaneously in a plane of the cutting member simultaneous oscillatory movements in the direction of the cutting edge and in a direction substantially at right angles to the cutting edge, the corresponding movements of the respective cutting members being out of phase, and the teeth of each cutting edge being adapted to each cut when moving individually in one direction in the direction of extent of the cutting edge, and a part of the first blade being positioned to be behind a part of the second blade, and the part of the second blade being positioned behind the part of the first blade whereby to restrict spreading between the blades.

In the alternate the respective parts are each offset to an alignment of an otherwise generally planar shape of a working area of each blade with each part being offset to an extent that such part is substantially within a planar alignment of the other blade.

In the alternate, each part of each blade is supported so as to extend as a portion of the respective blade with said part at an outer end of said portion.

In the alternate, each portion of each respective blade is positioned within an aperture of each respective blade and is aligned so as to generally project from a side of such aperture.

In an alternate, each blade has an aperture of mutually corresponding size and shape except that in the case of a one of the blades there is the portion projecting from a first side of the aperture, and in the case of the other blade the portion projects from an edge of the corresponding aperture in a direction that is approximately opposite to that of the direction of the said first portion.

In the alternate, a major portion of the cutting edge of each cutting member is a segment of a circle having an axis substantially co-incident with the respective pivot axis of the drive portion of said cutting member.

In the alternate each said cutting member is substantially planar with the drive portion extending laterally to the cutting edge intermediate a length of said cutting edge.

wherein said means to restrain movement includes a pair of links each pivotally supported at one end about a fixed axis parallel to said common axis, each of said links being pivotally connected at a second end to a respective one of said drive portions about said respective pivot axis parallel to and spaced from said common axis to establish said substantially linear movement.

wherein at the same end of the cutting edge of each said cutting member there is a substantially straight extension of the cutting edge extending in a direction inwardly with respect to the arcuate portion.

In the alternate, the blades are shaped to have within a working area of each blade, teeth of one section of each blade having an aligned motion which is more tangential to a curve of a teeth edge which is referred to as a nose of the blades while another section of the teeth edge which has a less tangential shaped motion, a heel of the blades.

In a further form then this invention can be said to reside in a cutting apparatus having teeth on respective outer selected edges of two juxtaposed blades means to effect an and then urging the relatively moving teeth on the edge of the respective blades against a surface to be cut, to provide for corresponding portions of the respective blades that each has a portion that is shaped and located so that a first portion supported by the first blade includes a part which is positioned behind a part of the other blade, and the second blade includes a portion with a part which is positioned behind the part of the first said blade.

In preference each blade has its part which is located behind the part of the other blade inset so that together the parts are of not substantially greater thickness than the juxtaposed blades overall thickness through a working area of the blades.

In preference the portions are each positioned to project into a larger aperture within each respective blade.

With the parts of the respective blades one being behind the other especially in positions in the blades prone to this blade flap problem reduces the problem expressed.

### BRIEF DESCRIPTION OF THE DRAWINGS

For a better understanding of this invention it will now be described with reference to a preferred embodiment which is described with the assistance of drawing wherein

FIG. 1 is a perspective view of two blades with accompanying supporting drives which include toward their nose interengaging parts in accordance with the embodiment,

FIG. 2 is a plan view from an opposite side of the view in FIG. 1,

FIG. 3 is a cross sectional view along the lines 2-2 in FIG. 2,

FIGS. 4a through 4d are successive views of the blades from a side elevation showing them as they move through the constrained relative movements provided by their support and drive mechanism, and

FIG. 5 is a side view of more of the details of an embodiment showing especially the arrangement by which the respective blades have their motion constrained by flexible blades.

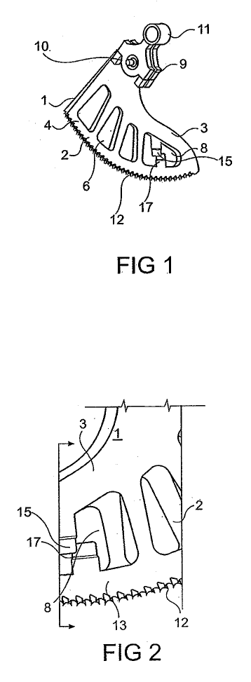

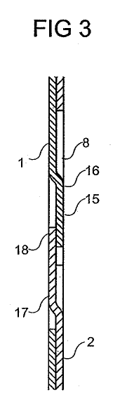

### DESCRIPTION OF THE EMBODIMENT

This invention is directed to a specific problem arising from a cutting mechanism which has been the subject of my previously referred to patent where two blades are positioned side by side or juxtaposed and each has a very similar shape and size and have along an outer edge a set of teeth.

The problem being addressed is that the blades when being driven through the approximately elliptical motions but out of phase one with respect to the other, would seem to rebound against each other so that the blades will rebound against each other and provide therefore in effect a spreading of the blades and therefore especially their respective sets of teeth. This seems to be a resonant rebound effect.

The problem with this is that the teeth themselves are the basis upon which a target is being cut so that if the blades are wide apart, then the cut will implicitly be wide apart and this introduces a number of other difficulties.

One of the reasons for the resonating effect is that the blades are selected to be as thin as possible and also have significant apertures all of which are intended to reduce inertia or weight and therefore effective load on any driving engine. The problem has been to find a way which does not interfere unduly with the ability to keep the blades very light and in fact springy, will not involve undue complexity and yet will perform reliably.

As can now be seen in the drawings there are two blades (1) and (2) each in the shape perhaps of a foot in which there is a forward portion at (3) which we refer to as the nose, and a rearward portion (4) which we shall refer to as the heel.

Each of the blades (1) and (2) has therefore a similar shape both in respect of its outer circumferential shape and a plurality of inner apertures shown typically at (5) and (6), (7) and (8).

The blades (1) and (2) are each constrained to move through a complex pathway which amounts substantially to an elliptical pathway but out of phase one with respect to the other by being retained within a control mechanism shown at (9) which includes a shaft (10) with eccentrics supported by the shaft (10) and a further retained portion (11) to effect this described action.

As has been previously explained the mechanism is fully explained in my earlier patent and it is in relation to this action and type of machine to which this improvement applies.

Each blade (1) and (2) includes along a selected outer most edge a set of teeth shown at (12) in one case and (13) in the other.

Within the aperture (8), according to this embodiment, for blade (1) there is a tongue (14) that protrudes from an edge of the aperture (8) in respect of blade (1) as a portion of an edge of the aperture (8) and the tongue (14) has this protruding portion at the end of which is a part (15) which is shaped so as to be offset at (16) so that the part (15) being a generally planar part, aligns with the otherwise generally planar shape of the working area of blade (2).

Now there is a further tongue (17) attached to blade (2) and protruding as a portion from an edge of the aperture area (8) which has a portion which has an outer most part (18) which is a planar part which is offset from the planar alignment with blade (2) so that it is in fact aligned with the planar alignment of a working area of blade (1).

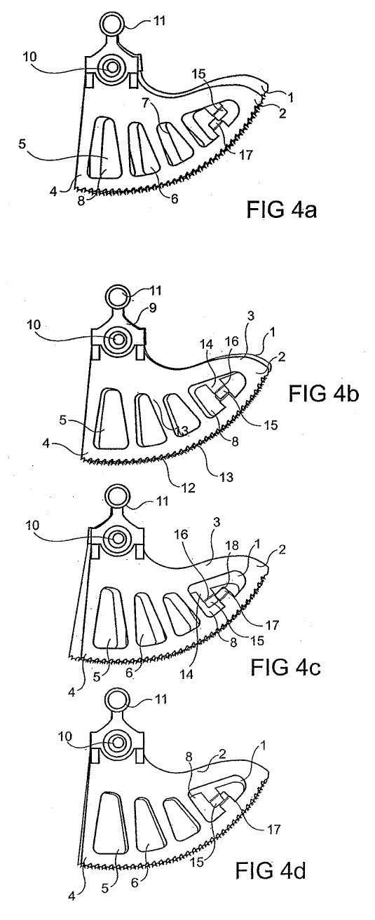

The parts (15) and (18) are positioned so that they will maintain an overlapping relative position through all of the respective changes of position of blades (1) and (2) as is shown through the sequence of FIGS. 4a through 4d.

Further, each of the portions (14) and (17) are shaped together with the surrounding circumference of the aperture (8) so that there will not be a closing together of the part of one blade as compared to the side of the aperture (8) in the other blade to an extent that a finger thickness would be captured and perhaps crushed thereby.

This is achieved by positioning the respective portions and parts mid-way within a relatively large aperture shape.

The respective parts (15) and (18) of blades (1) and (2) thereby inter-engage one with respect to the other so that they do not permit the widening or spreading between blades (1) and (2) when they are being used.

The result of these modifications to the blades has allowed the blades to be economically manufactured and by reason that two respective parts do not of themselves extend beyond the thickness of the combined blades (1) and (2), means that they do not add to any general thickness of a cut.

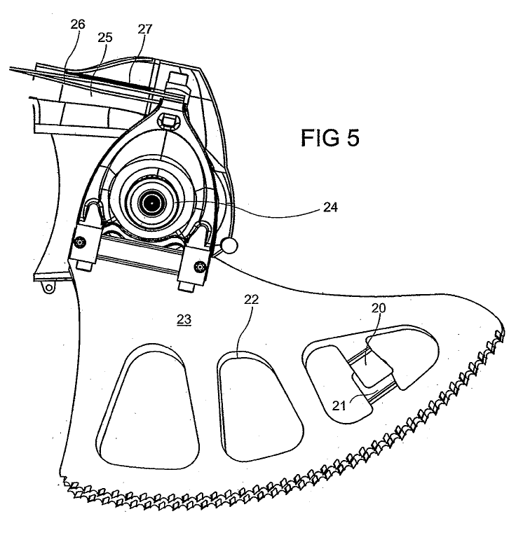

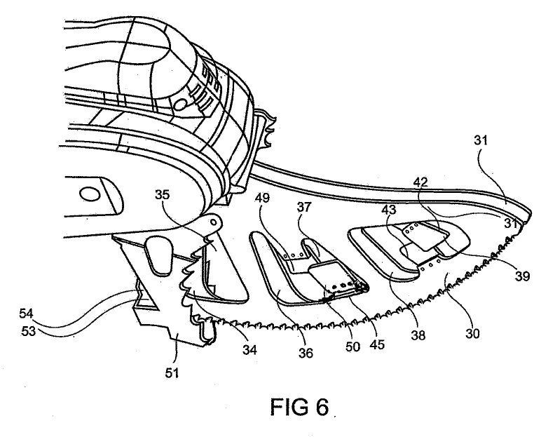

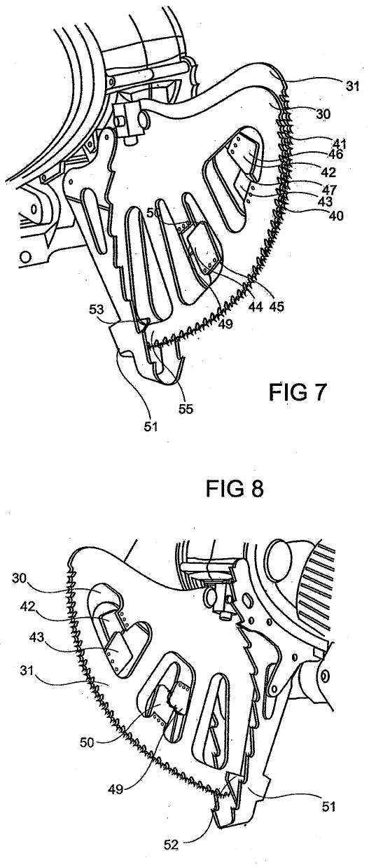

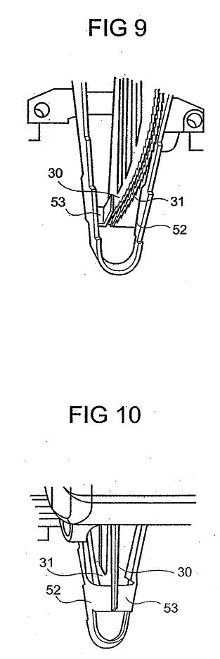

Now referring to FIG. 5 this is a side view in greater detail of an assembly using the interengaging parts as shown at (20) and (21) of blades (22) and (23).

The driving mechanism for these blades is as previously described in our previous patent which for the sake of illustration includes for each blade an eccentric drive (24) with a further portion of the blade support structure being tied to a portion of the body (25) by respective flexible blades (26) and (27).

This mechanism is fully expounded in my earlier patent which is included herein by reference.

The improvement has been of significant advantage in relation to this cutting method which in itself is providing significant advantage.

Cutting is achieved by urging the cutting edges (12) and (13) which work together against a material to be cut. This can be masonry or timber.

### SUMMARY

Blade resonance or flap particularly at a nose of the respective blades seems to be caused by a resonance arising during some orbit oscillation rates, blade lengths and blade thickness's. At some revolutions per minute, the nose of the blades is found to separate by up to 100 mm if not restrained. This could be overcome by using thicker more rigid blades but even then in some circumstances they would separate such as when cutting at the heel. Blade resonance or flap also implicitly increases load on the mechanism and motor well above that ordinarily caused by the mass of the blades.

Blade thickness—The cut rate is directly proportional to the thickness of the cut. Using interengaging portions of the blades has allowed a reduction of 33.3% in the joint blade thickness with related decrease in weight and increase in cutting speed in one typical instance.

Blade Length—Blade length can be effectively doubled in some cases with the same thickness of blades using this concept.

Load on motor and mechanism—because the blades are constantly accelerated due to the orbital or elliptical shaped pathway, the load is proportionally reduced by reduced weight of the blades.

In order to keep the overall thickness of the two blades and therefore the cut width constrained the interengaging parts do not in the embodiment extend beyond the combined thickness of the portions of the two blades that may enter a cut.

The interengaging parts are not reduced in the thickness but remain completely within the planar thickness of the other blade and vice versa.

The area between each blade and the interlock portion of the other blade, is chosen at every stage of the orbit, not to cause a reduction of area such that it can sever a finger.

There can be further parts that interengage so that there can be two or more interengaging locations for a same set of juxtaposed blades.

1. A cutting apparatus having two juxtaposed blades with each having an outermost cutting edge, with retention and driving of the blades adapted to effect an oscillatory motion to each of the cutting edges, a first of the blades having a first portion supported by the first blade with a part which is positioned behind a part of the other blade, and a second blade includes a portion with a part which is positioned behind the part of the first said blade.

2. A cutting apparatus as claimed in claim 1 further comprised in that each blade has its part which is located behind the part of the other blade inset so that together the parts are of not substantially greater thickness than the juxtaposed blades overall thickness through a working area of the blades.

3. A cutting apparatus as claimed in claim 1 further comprised in that the portions are each positioned to project into an aperture within each respective juxtaposed blade.

4. A cutting apparatus as claimed in claim 1 in which the cutting edges include teeth.

5. A cutting tool comprising two cutting members with toothed cutting edges positioned side by side, each respective cutting member being mounted on a respective eccentric of a drive shaft coupled to a motor, each cutting member being guided by a respective control link adapted that the cutting edge of each cutting member prescribes simultaneously in the plane of the toothed cutting edge, simultaneous oscillatory movements in the direction of the toothed edge and in a direction of right-angles thereto with corresponding movements of the respective cutting members being out of the phase, and the teeth of each cutting edge being adapted to each cut when moving individually in the direction of the toothed edge, a first of the blades having a first portion supported by the first blade with a part which is positioned behind a part of the other blade, and a second blade includes a portion with a part which is positioned behind the part of the first said blade.

6. A cutting tool as claimed in claim 5 further comprised in that each part is offset with respect to a planar alignment of the blade of which it forms a portion to be substantially aligned with the body of the other blade.

7. A cutting tool comprising two juxtaposed cutting members each having a toothed cutting edge of a substantially same shape and length, each of said cutting members having a drive portion extending in a direction lateral to the cutting edge, said drive portions being in a juxtaposed relation; a drive means adapted for coupling to a motor and operably interacting with each said drive portions to impart thereto an eccentric movement in a plane of each respective said drive portion about a common axis, the eccentric movement imparted to the respective drive portions being equal and angularly out of phase; and means to restrain movement of the respective drive portions at a specific location spaced from said common axis to substantially linear movement in a direction radial to the common axis and to angular movement about a respective pivot axis parallel to said common axis, whereby in response to activation of the drive means, the cutting edge of each cutting member prescribes simultaneously in a plane of the cutting member simultaneous oscillatory movements in the direction of the cutting edge and in a direction substantially at right angles to the cutting edge, the corresponding movements of the respective cutting members being out of phase, and the teeth of each cutting edge being adapted to each cut when moving individually in one direction in the direction of extent of the cutting edge, and a first of the blades having a first portion supported by the first blade with a part which is positioned behind a part of the other blade, and a second blade includes a portion with a part which is positioned behind the part of the first said blade.

8. A cutting tool as claimed in claim 7 further comprised in that the respective parts are each offset to an alignment of an otherwise generally planar shape of a working area of each blade with each part being offset to an extent that such part is substantially within a planar alignment of the other blade.

9. A cutting tool as claimed in claim 7 further comprised in that each part of each blade is supported so as to extend as a portion of the respective blade with said part at an outer end of said portion.

10. A cutting tool as claimed in claim 7 further comprised in that each portion of each respective blade is positioned within an aperture of each respective blade and is aligned so as to generally project from a side of such aperture.

11. A cutting tool as claimed in claim 9 further comprised in that each blade has an aperture of mutually corresponding size and shape except that in the case of a one of the blades there is the portion projecting from a first side of the aperture, and in the case of the other blade the portion projects from an edge of the corresponding aperture in a direction that is approximately opposite to that of the direction of the said first portion.

12. A cutting tool as claimed in claim 9 further comprised in that a major portion of the cutting edge of each cutting member is a segment of a circle having an axis substantially co-incident with the respective pivot axis of the drive portion of said cutting member.

13. A cutting tool as claimed in claim 9 further comprised in that each said cutting member is substantially planar with the drive portion extending laterally to the cutting edge intermediate a length of said cutting edge wherein said means to restrain movement includes a pair of links each pivotally supported at one end about a fixed axis parallel to said common axis, each of said links being pivotally connected at a second end to a respective one of said drive portions about said respective pivot axis parallel to and spaced from said common axis to establish said substantially linear movement and wherein at the same end of the cutting edge of each said cutting member there is a substantially straight extension of the cutting edge extending in a direction inwardly with respect to the arcuate portion.

14. A method of cutting material which comprises the steps of urging the cutting edges of a cutting tool as claimed in claim 5 into a material to be cut while effecting a driving of each of the cutting members in an oscillatory motion.

15. A method of cutting material which comprises the steps of urging the cutting edges of a cutting tool as claimed in claim 7 into a material to be cut while effecting a driving of each of the cutting members in an oscillatory motion.

16. A cutting tool as claimed in claim 8 further comprised in that each part of each blade is supported so as to extend as a portion of the respective blade with said part at an outer end of said portion.

17. A cutting tool as claimed in claim 16 further comprised in that each portion of each respective blade is positioned within an aperture of each respective blade and is aligned so as to generally project from a side of such aperture.

18. A cutting tool as claimed in claim 16 further comprised in that each blade has an aperture of mutually corresponding size and shape except that in the case of a one of the blades there is the portion projecting from a first side of the aperture, and in the case of the other blade the portion projects from an edge of the corresponding aperture in a direction that is approximately opposite to that of the direction of the said first portion.

19. A cutting tool as claimed in claim 18 further comprised in that a major portion of the cutting edge of each cutting member is a segment of a circle having an axis substantially co-incident with the respective pivot axis of the drive portion of said cutting member.

20. A cutting tool as claimed in claim 19 further comprised in that each said cutting member is substantially planar with the drive portion extending laterally to the cutting edge intermediate a length of said cutting edge wherein said means to restrain movement includes a pair of links each pivotally supported at one end about a fixed axis parallel to said common axis, each of said links being pivotally connected at a second end to a respective one of said drive portions about said respective pivot axis parallel to and spaced from said common axis to establish said substantially linear movement and wherein at the same end of the cutting edge of each said cutting member there is a substantially straight extension of the cutting edge extending in a direction inwardly with respect to the arcuate portion.
